(19) United States
(12) Patent Application Publication
(10) Pub. No.: US 2006/0106625 A1
(43) Pub. Date: May 18, 2006

(54) System and method for coordinating real estate transactions through a global communications network

(76) Inventor: Barry J. Brown, West Jordan, UT (US)

Correspondence Address: Starkweather and Associates, Suite 200, 9035 South 1300 East, Sandy, UT, 84094, US

(21) Appl. No.: 10/987,892

(22) Filed: Nov. 12, 2004

(51) Int. Cl. G06Q 99/00

(52) U.S. Cl. 705/1

(57) ABSTRACT

A system and method to facilitate real estate transactions over a global communications network. The system includes a listings database to store information of real estate to be sold, a registration module to obtain qualifying information from a potential buyer, a system processing module to qualify a potential buyer to view specific real estate information stored on the listings database based on the qualifying information provided by the potential buyer and a seller's predetermined criteria, and a display to display the real estate to the potential buyer. The system may further include a search module to search the listings database for real estate matching potential buyer preferences, a bidding module to allow the potential buyer to submit a real estate purchase proposal, a scheduler module to determine dates and times for the potential buyer to physically view chosen real estate, a system processing module to determine a most efficient route for viewing the chosen real estate with respect to visiting date and time and location of the chosen real estate, and a mapping module to provide directions to view the chosen real estate in the most efficient route.

### BACKGROUND OF THE INVENTION

1. Field of the Invention

This invention relates to computerized systems and methods for the real estate business. More particularly, this invention relates to a system and method for listing, selling, coordinating, and finalizing sales of real estate over an internet connection.

2. Description of the Related Art

Currently, 12,300,000 people list their homes for sale each year. 3,200,000 sellers try to sell their homes without the assistance of a real estate agent, but most ultimately obtain a real estate agent. The most effective way to buy or sell a home is through the use of a real estate agent. The reason for this is not because of the agent's legal knowledge, abilities in negotiating, or marketing of the home, but rather in the agent's proprietary access to the multiple listing service. The multiple listing service is a database of listed properties commonly used by listing agents to list properties to be shown by buyers' agents (“showing agents”). For the privilege of being listed on the multiple listing service the seller must agree to give the agent six to eight percent of the sales price of the home. This means that the sellers have six to eight percent less equity to work with to help the buyers purchase their home.

Real estate transactions typically involve the use of real estate agents to set up and coordinate real estate showings and sales. The seller of a property uses a listing agent to act as an agent to organize and facilitate the sale of property and to submit a listing to a listing office and to a multiple listing service. After a showing agent finds a suitable property listing from the multiple listing service, the showing agent requests from the listing office an appointment time by telephone to view and show the property. Such a request may be for a specific time or may be an open-ended request for a suitable time from the seller. An agent or staff member at the listing office then communicates with the seller to determine if the requested showing time is acceptable. The seller's message is subsequently communicated from the listing office to the showing office, and the listing office will also let the listing agent know of scheduled showings. The process continues until the seller sells the home.

The current method of buying or selling a home through real estate agents suffers from a number of disadvantages. First, the method requires a great deal of human interaction on behalf of both the listing office, the showing agent, and the showing office, which increases costs and requires real estate agents to spend a significant amount of time scheduling appointments. Second, it is the agent who determines which home the buyer should view. Third, agents waste hours searching for homes only to find that the buyers are not interested in any of them, or that the buyers do not satisfy income requirements. Fourth, sellers do not want to pay six to eight percent of their homes value to an agent for, at times, very little work by the agent. Fifth, many sellers do not want random home searchers passing through their home if the home searcher does not have the means to purchase the home, and if the home searcher is merely casing the home to prepare for a crime. Too many people take a “window shopping” approach to the home market and waste too much home seller time by visiting homes that are for sale even though they have no intention of buying it. Sixth, home buyers have limited time and are usually only available on the evenings and on the weekends.

From the foregoing discussion, it should be apparent that a need exists for a system and a method that registers potential real estate purchasers for particular real estate, protects real estate sellers from unqualified real estate shoppers, and that communicates selling real estate status to interested buyers. Beneficially, such a system and method would facilitate the real estate selling and buying process.

### SUMMARY OF THE INVENTION

The present invention has been developed in response to the present state of the art, and in particular, in response to the problems and needs in the art that have not yet been fully solved by currently available systems for facilitating real estate transactions over a global communications network. Accordingly, the present invention has been developed to provide a system and method for facilitating real estate transactions over a global communications network that overcome many or all of the above-discussed shortcomings in the art.

A system of the present invention is presented to facilitate real estate transactions over a global communications network. The system may be embodied to include a listings database configured to store information of real estate to be sold, a registration module configured to obtain qualifying information from a potential buyer, a system processing module configured to qualify a potential buyer to view specific real estate information stored on the listings database based on the qualifying information provided by the potential buyer and a seller's predetermined criteria, and a display configured to display the real estate to the potential buyer.

In one embodiment, the listings database stores real estate information, such as real estate location, real estate size, number of rooms, square footage, parcel size, number of baths/showers, basement, floors, appliances, size of garage, asking price, amenities, school district, and year built.

In another embodiment, the system includes a search module configured to search the listings database for real estate matching potential buyer preferences, and a bidding module configured to allow the potential buyer to submit a real estate purchase proposal.

The system, in yet another embodiment, includes a display to display the information of the real estate to a potential buyer, a scheduler module configured to determine dates and times for the potential buyer to physically view chosen real estate, a system processing module configured to determine a most efficient route for viewing the chosen real estate with respect to visiting date and time and location of the chosen real estate, and a mapping module configured to provide directions to view the chosen real estate in the most efficient route.

The system, in still another embodiment, includes a communications module configured to notify the interested potential buyers of the status of the chosen real estate. In one embodiment, the communications module notifies all potential buyers who have indicated an interest in viewing the chosen real estate when the chosen real estate sells. In another embodiment, the communications module distributes an electronic message to the potential buyers of the chosen real estate sale and instructs the potential buyers that all future planned viewings are cancelled. The communications module may also be configured to notify all potential buyers who have indicated an interest in viewing the chosen real estate when a bid on the chosen real estate has been made and invite the potential buyers to also make a bid.

A method of the present invention is also presented for facilitating the real estate transaction. The method in the disclosed embodiments substantially includes the steps necessary to carry out the functions presented above with respect to the operation of the described apparatus and system. In one embodiment, the method includes providing a listings database configured to store information of real estate to be sold, providing a registration module configured to obtain qualifying information from a potential buyer, providing a system processing module configured to qualify a potential buyer to view specific real estate information stored on the listings database based on the qualifying information provided by the potential buyer and a seller's predetermined criteria, and providing a display configured to display the real estate that the potential buyer.

In another embodiment, the method includes the step of providing a search module configured to search the listings database for real estate matching potential buyer preferences, and providing a bidding module configured to allow the potential buyer to submit a real estate purchase proposal.

The method, in yet another embodiment, includes providing a scheduler module configured to determine dates and times for the potential buyer to physically view chosen real estate, providing a system processing module configured to determine a most efficient route for viewing the chosen real estate with respect to visiting date and time and location of the chosen real estate, and providing a mapping module configured to provide directions to view the chosen real estate in the most efficient route.

The method, in still another embodiment, includes providing a communications module configured to notify interested potential buyers of the status of the chosen real estate. In one embodiment, the communications module notifies all potential buyers who have indicated an interest in viewing the chosen real estate when the chosen real estate sells. In another embodiment, the communications module distributes an electronic message to the potential buyers of the chosen real estate sale and instructs the potential buyers that all future planned viewings are cancelled. The communications module may also be configured to notify all potential buyers who have indicated an interest in viewing the chosen real estate when a bid on the chosen real estate has been made and invite the potential buyers to also make a bid.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a flow chart of a system for coordinating real estate transactions according to one embodiment of the present invention;

FIG. 2 illustrates an exemplary display for viewing real estate for unqualified potential buyers according to one embodiment of the present invention;

FIG. 3 illustrates an exemplary display for viewing real estate for qualified potential buyers according to one embodiment of the present invention;

FIGS. 4A-4C illustrate a schedule display according to one embodiment of the present invention; and

FIG. 5 illustrates a map and directions for visiting particular real estate according to one embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

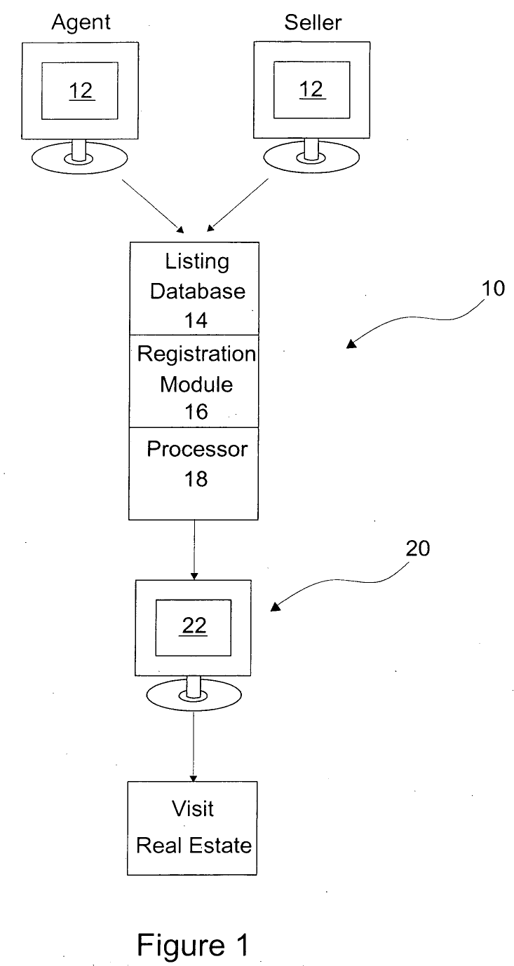

FIG. 1 illustrates a system 10 to coordinate real estate transactions over a global communications network according to one embodiment of the present invention. The system includes a user's processor 12, which may be used by a seller or an agent, a listings database 14, a registration module 16, a system processor 18, a second user processor 20, which may also be used by a buyer, and a display 22.

In one embodiment, the listings database 14 is configured to store information of real estate to be sold, such as, but not limited to, real estate location, real estate size, number of rooms, square footage, parcel size, number of baths/showers, basement, floors, appliances, size of garage, asking price, amenities, school district, and year built.

The registration module 16 is configured to obtain qualifying information from a potential buyer to determine a level of qualification. It is noted that many people who actually view homes are not, in actuality, interested in buying the home. Rather, many times a home seller is flooded with questions about the price of the home and the home seller wastes much of the time showing the home to people who merely enjoy viewing homes as a pastime. The registration module 16 serves to obtain the qualifying information to “screen” true potential buyers from those who are merely passing time.

In one embodiment, the information obtained from the registration module is name, address, driver's license number, and proof of financial qualification. The proof of financial qualification may be proof of a loan approval for a fixed amount, a qualification for a fixed amount, or a credit score. Loan approval may be provided from the potential buyer's bank, loan officer, etc., and the system 10 may be configured to analyze the buyer's financial information provided by the buyer to determine a loan qualification amount.

The system processing module 18 analyzes the qualifying information to qualify the potential buyer for a certain level of purchasing power. In one embodiment, the system 10 may be accessed by financial organizations, such as banks, mortgage companies, and financial officers. A potential buyer can go to the financial organization and be pre-approved for a fixed loan amount or be pre-qualified for a loan. The financial organization can subsequently access the system 10 and automatically qualify the potential buyer for a level of purchasing power according to the financial organization's rules. In another embodiment, the system processing module 18 may be configured to retrieve the potential buyer's credit report and analyze the data therein to qualify the potential buyer based on the potential buyer's credit score.

In still another embodiment, the system processing module 18 may be configured to apply rules of qualification liberally or strictly, based on seller preferences. For example, credit score ranges may be established, such that potential buyers who fall within the credit score range qualify for particular levels, or potential buyers below certain credit scores are disqualified.

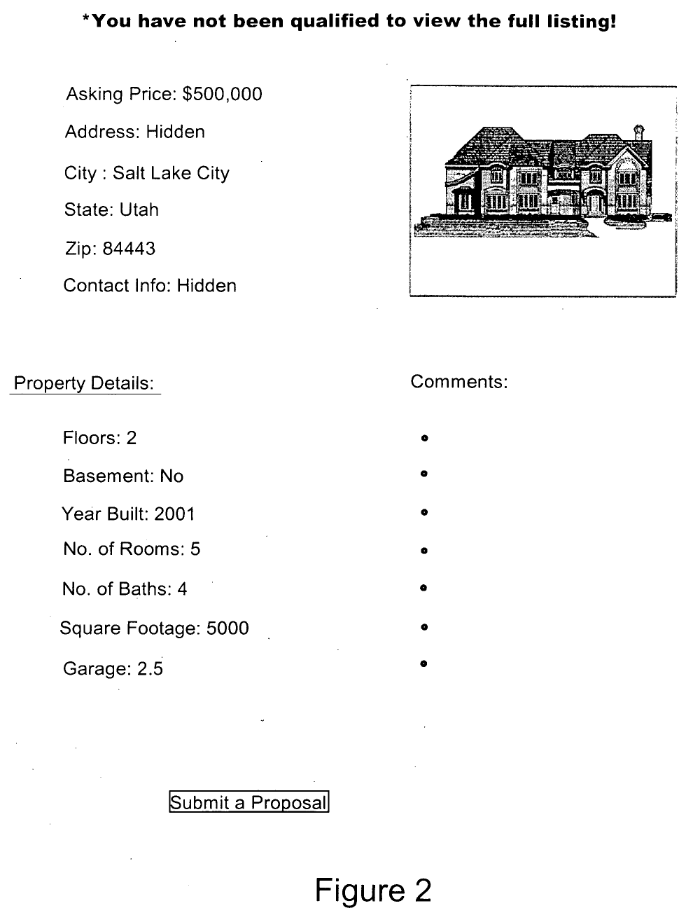

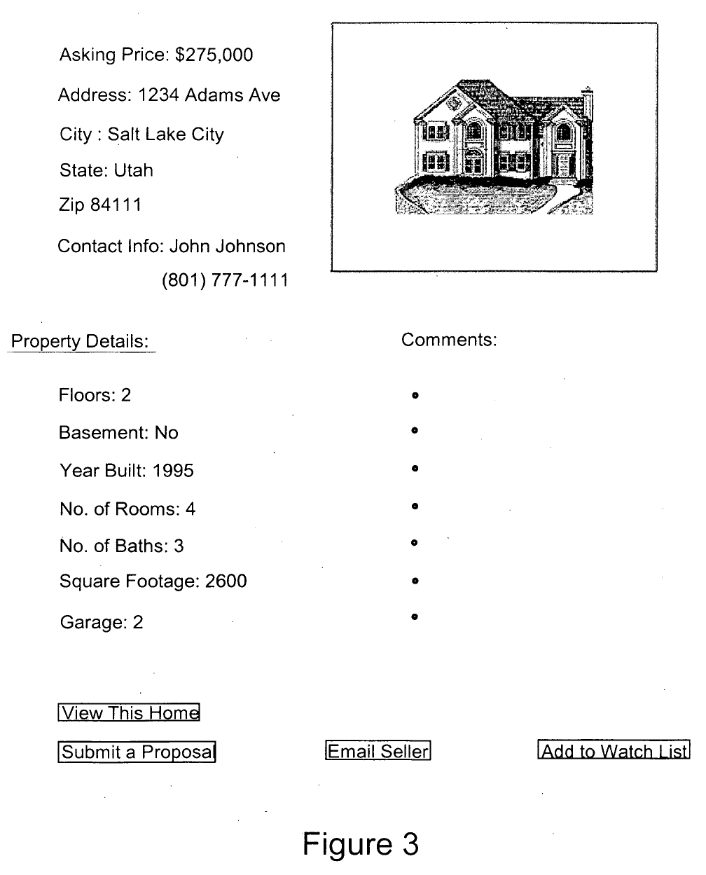

FIGS. 2 and 3 illustrate exemplary views of a display for real estate information for unqualified and qualified buyers, respectively. The listings database 14 includes all information related to real estate intended to be sold. The information can be input by a mortgage lender, a real estate agent, a representative, the seller, or another person involved in the sale of the real estate. Mortgage lenders, real estate agents, and representatives will have personal face-to-face contact with the sellers. They deliver the signs, take pictures of the property, input the real estate information on the internet, and direct customer service. In one embodiment, the system processing module 18 displays only limited real estate information for all real estate stored on the listings database to unqualified potential buyers, and displays all real estate information for all real estate listings stored on the listings database to the qualified potential buyers. Specifically, as illustrated in FIG. 2, if the system processing module 18 determines that the potential real estate purchaser is unqualified to purchase a $500,000 home, the specific address and contact information for the home is hidden. The potential buyer can still view limited real estate information for the home, such as lot size, home size, bedrooms, etc., and do virtual tours of the property. In one embodiment, the unqualified potential buyer may still request, through electronic mail, or voice mail, a viewing of the real estate with the real estate owner. The real estate owner has the option of responding and granting access to the hidden information or denying access, or ignoring the message.

Referring now to FIG. 3, all real estate information is available to qualified potential buyers. As discussed above, potential buyers may become qualified after registering through the registration module and providing qualifying information. In the illustrated example, the asking price for the home is $275,000. Potential buyers who have been qualified to purchase real estate worth $275,000 level can, therefore, view all the information about the home, including address and contact information.

In another example, the home seller may establish preferences that allow potential buyers who may not be qualified to purchase to at least view the home information. In yet another example, the home seller may establish strict preferences that absolutely prohibit the sharing of the information to unqualified potential buyers.

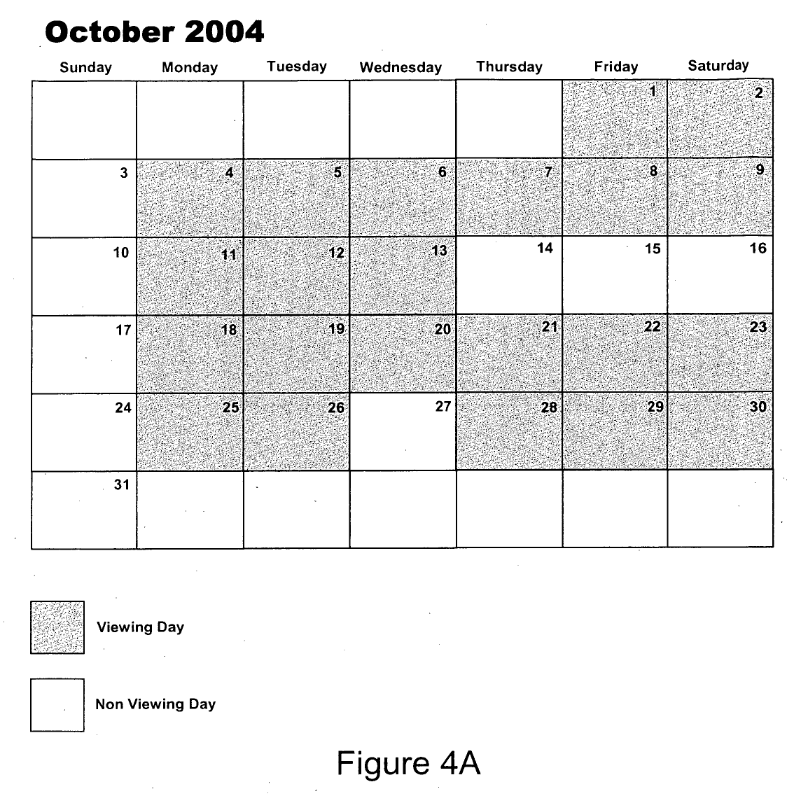

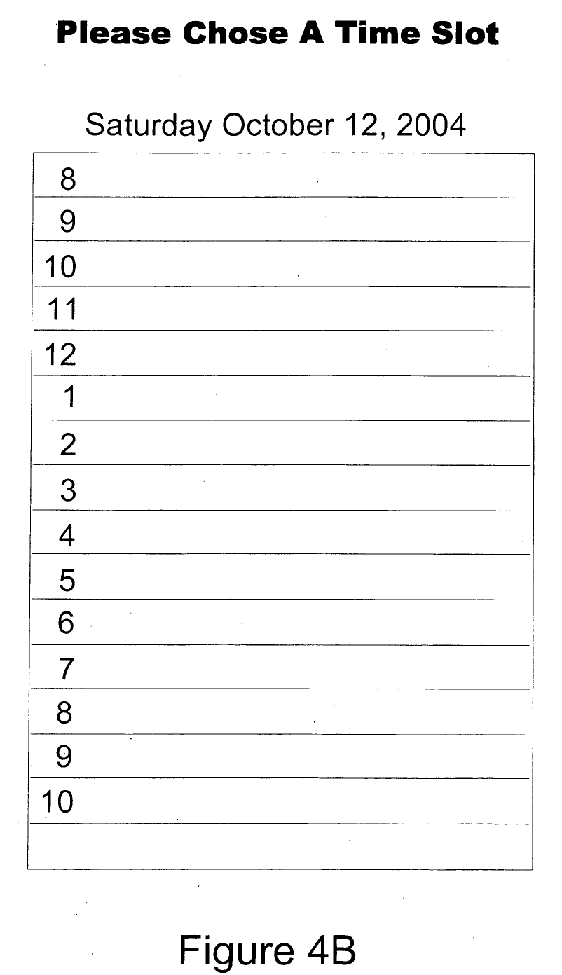

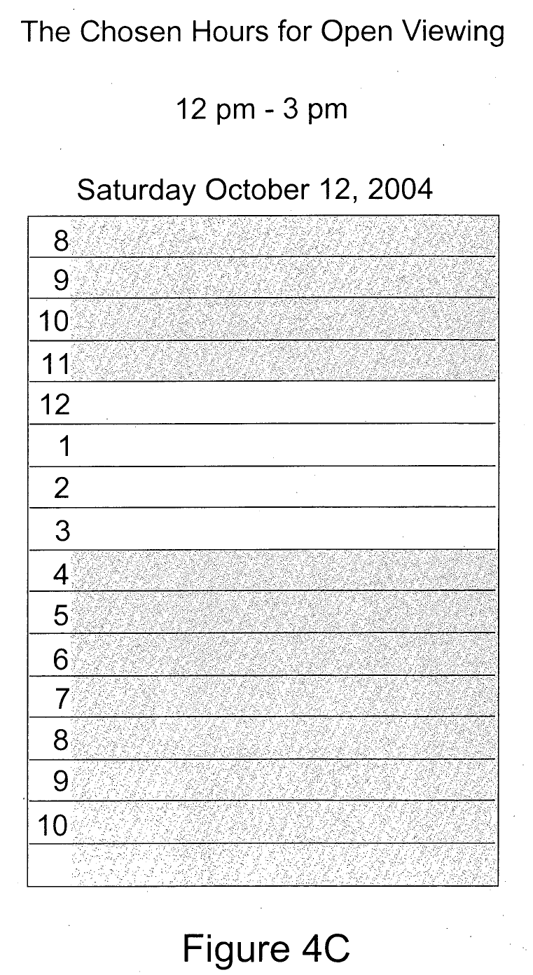

FIGS. 4A-4C illustrate exemplary views of a scheduler module according to one embodiment of the present invention. The potential buyer can search the scheduler module to coordinate a time to physically view the chosen real estate. In one embodiment, the seller of the real estate configures the scheduler module with dates and times available for meeting with potential buyers to physically view the real estate. The seller can use color coding to indicate ideal viewing times, or less than ideal viewing times. For example, green time spots indicate the best times to view the real estate and red time spots indicate poor times to view the real estate. In another embodiment, the potential buyer views the schedule, picks dates (See FIG. 4A) and chooses a time (See FIG. 4B). The scheduler module then notifies the seller that a potential buyer has selected a date and time to physically view the real estate.

In another embodiment, the seller programs the scheduler module with fixed viewing time slots such that the potential buyer is allowed to view the real estate during any of the available time slots (See FIG. 4C). An exact viewing time is not necessary; rather, the real estate is available at any time shown in the scheduler module, and the potential viewer need only stop by within the predetermined time slot.

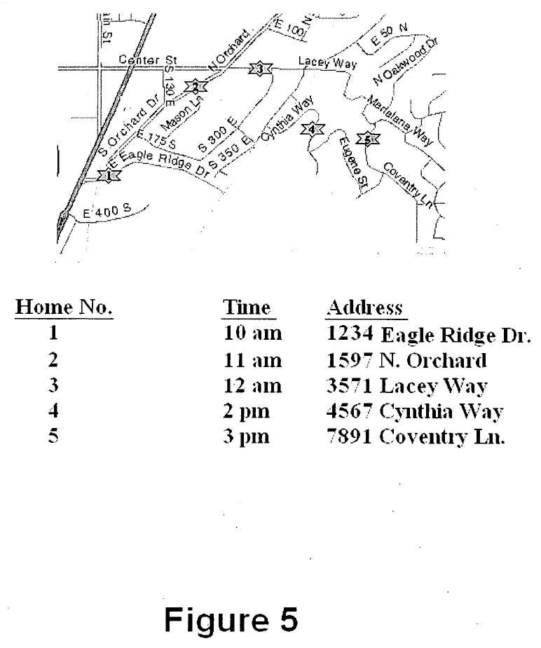

The potential buyer may search through the real estate listed in the listings database 14 (See FIG. 1) and fix viewing appointments with numerous real estate sellers. The processing module tracks the homes that the potential buyer has established appointments with and, in one embodiment, determines a most efficient route for viewing the chosen real estate with respect to visiting date and time and location of the chosen real estate. A mapping module provides directions to view the chosen real estate in the most efficient route (See FIG. 5). Accordingly, viewing of the real estate is made simpler and more efficient. A map may be provided to further simplify the viewing process.

After viewing the homes, the potential buyer may submit a real estate purchase proposal, or bid on the real estate. The real estate purchase proposal may include a proposed purchase price and further details outlining date of sale, terms and conditions, fixtures, etc. The system may be configured to provide all the information necessary to the potential buyer, and seller, to assist in making proposals and counter-proposals. The system sends the proposal to the seller for the seller's review and comment.

In one embodiment, the potential buyer can submit bids for multiple real estates. The potential buyer gathers a list of chosen real estate, lists the real estate in preferred order, and submits bids for each real estate. The potential buyer may not win the bid for each chosen real estate, however, the potential buyer would be contractually obligated to buy the highest ranked winning real estate. Failure to buy the real estate may be grounds for prohibition from use of the service.

The seller and buyer have all necessary forms available on the website. Vendors, services, appraisers, etc., are listed to assist in closing the sale, if necessary. In one embodiment, either party draws up the sales contract on their own, or with the aid of whomever they want, with the help of the materials available through the website, or use of an attorney listed on the web site, for a fee. The fees are set by the vendors. In another embodiment, title and/or escrow companies will have their legal department do the initial real estate purchase contract and necessary disclosures at little or no cost to the buyers or sellers when the buyers or sellers commit to using the title company for their title insurance. A comments and grading system is available to provide feedback on the quality of service provided.

If the seller and potential buyer reach an agreement as to the terms of sale, the system 10 notifies all interested potential buyers that the real estate has been sold. Specifically, a communications module notifies the other interested potential buyers of the status of the chosen real estate. In another embodiment, the communications module may be configured to distribute an electronic message to potential buyers of the chosen real estate sale and instructs the potential buyers that all future planned viewings are cancelled. In still another embodiment, the communications module notifies all potential buyers who have indicated an interest in viewing the chosen real estate when a purchase proposal, or bid on the chosen real estate has been made and invites the potential buyers to also make a bid.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification discusses the use of using financial organizations, chosen by the potential buyer, to pre-qualify for a level of purchasing power, it is also envisioned that potential buyers can pre-qualify through a strategic partner of the system. A strategic partner may be a real estate agent, a banking facility, a mortgage lender, or other person with a knowledge of the real estate industry. When a homebuyer views a home on the listings database 14 that they are interested in seeing and the home requires a pre-qualification or pre-approval and the homebuyer is not already approved, a link immediately enables the homebuyer to enter information to get pre-approved. The request is sent to a strategic partner responsible for the homebuyer's zip code, which is processed and a level of qualification is established.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system to coordinate real estate transactions over a global communications network, the system comprising:
a listings database configured to store information of real estate to be sold;
a registration module configured to obtain qualifying information from a potential buyer;
a system processing module configured to qualify the potential buyer to view specific real estate information stored on the listings database based on the qualifying information provided by the potential buyer and a seller's predetermined criteria; and
a display configured to display the real estate information that the potential buyer.

2. The system of claim 1, wherein the listings database stores real estate information selected from the group consisting of: real estate location, real estate size, number of rooms, square footage, parcel size, number of baths/showers, basement, floors, appliances, size of garage, asking price, amenities, school district, and year built.

3. The system of claim 1, wherein the system processing module allows an unqualified potential buyer to view only limited real estate information for all real estate stored on the listings database, and allows a qualified potential buyer to view all real estate information for all real estate listings stored on the listings database.

4. The system of claim 3, wherein the system processing module prevents the potential buyer from viewing physical addresses and contact information of real estate listed on the listings database to which the potential buyer is not qualified to purchase.

5. The system of claim 1, wherein the system processing modules analyzes and matches the information obtained from the registration module and determines a level of real estate qualification.

6. The system of claim 5, wherein the information obtained from the registration module is proof of financial qualification, and wherein the proof of financial qualification is selected from the group consisting of: a loan approval for a fixed amount, a qualification for a fixed amount, and a credit score.

7. The system of claim 1, further comprising a search module configured to search the listings database for real estate information matching potential buyer preferences.

8. The system of claim 1, further comprising a bidding module configured to allow the potential buyer to submit a real estate purchase proposal.

9. A system to coordinate real estate transactions over a global communications network, the system comprising:
a listings database configured to store information of real estate to be sold;
a display to display the information of the real estate to a potential buyer;
a scheduler module configured to determine dates and times for the potential buyer to physically view chosen real estate;
a system processing module configured to determine a route for viewing the chosen real estate with respect to visiting date and time and location of the chosen real estate; and
a mapping module configured to provide directions to view the chosen real estate.

10. The system of claim 9, wherein the scheduler module requires the potential buyer to choose a date and time to physically view the real estate from an available time slot.

11. The system of claim 10, wherein a seller of the chosen real estate receives confirmation of the date and time that the potential buyer will view the real estate.

12. The system of claim 9, wherein a seller programs the scheduler module with fixed viewing time slots, and wherein the potential buyer is allowed to view the real estate during any of the viewing time slots.

13. The system of claim 9, further comprising a bidding module configured to allow the potential buyer to submit a real estate purchase proposal.

14. The system of claim 9, further comprising a search module configured to search the listings database for real estate matching potential buyer preferences.

15. A system to coordinate real estate transactions over a global communications network, the system comprising:
a listings database configured to store information of real estate to be sold;
a display to display the information of the real estate to a potential buyer;
a scheduler module configured to schedule viewing dates with the potential buyer when the potential buyer indicates an interest in physically viewing a chosen real estate; and
a communications module configured to notify other interested potential buyers of the status of the chosen real estate.

16. The system according to claim 15, wherein the communications module notifies all potential buyers, who have indicated an interest in viewing the chosen real estate, when the chosen real estate sells.

17. The system according to claim 16, wherein the communications module distributes an electronic message to all potential buyers when the chosen real estate is sold, and instructs the potential buyers that all future planned viewings are cancelled.

18. The system of claim 15, further comprising a bidding module configured to allow a potential buyer to submit a real estate purchase proposal.

19. The system according to claim 18, wherein the communications module notifies all potential buyers who have indicated an interest in viewing the chosen real estate when a bid on the chosen real estate has been made and invites the potential buyers to also make a bid.

20. The system of claim 15, wherein the listings database stores real estate information selected from the group consisting of: real estate location, real estate size, number of rooms, square footage, parcel size, number of baths/showers, basement, floors, appliances, size of garage, asking price, amenities, school district, and year built.

21. A method for coordinating real estate transactions over a global communications network, the system comprising:
providing a listings database configured to store information of real estate to be sold;
providing a registration module configured to obtain qualifying information from a potential buyer;
providing a system processing module configured to qualify the potential buyer to view specific real estate information stored on the listings database based on the qualifying information provided by the potential buyer and a seller's predetermined criteria; and
if qualified, displaying the specific real estate information to the potential buyer.

22. The method of claim 21, further including the step of:
providing a search module to search the listings database for real estate matching potential buyer preferences; and
providing a bidding module configured to allow the potential buyer to submit a real estate purchase proposal.

23. The method of claim 21, further comprising the steps of:
providing a scheduler module configured to determine visiting dates and times for the potential buyer to physically view chosen real estate;
providing a system processing module configured to determine a most efficient route for viewing the chosen real estate with respect to visiting date and time and location of the chosen real estate; and
providing a mapping module configured to provide directions to view the chosen real estate in the most efficient route.

24. The method of claim 23, further comprising the step of providing a communications module configured to notify interested potential buyers of the status of the chosen real estate.

25. The method of claim 24, wherein the communications module notifies all potential buyers who have indicated an interest in viewing the chosen real estate when the chosen real estate sells.

26. The method of claim 25, wherein the communications module distributes an electronic message to the potential buyers of the chosen real estate sale and instructs the potential buyers that all future planned viewings are cancelled.
